(19) United States
(12) Patent Application Publication
(10) Pub. No.: US 2006/0125164 A1
(43) Pub. Date: Jun. 15, 2006

(54) Resilient bushing mount for a vehicle suspension

(75) Inventors: Mark J. Mansueto, Utica, MI (US); Mark C. Smith, Troy, MI (US)

Correspondence Address: CARLSON, GASKEY & OLDS, P.C., 400 WEST MAPLE ROAD, SUITE 350, BIRMINGHAM, MI, 48009, US

(73) Assignee: Meritor Suspension Systems Company, Inc.

(21) Appl. No.: 11/350,415

(22) Filed: Feb. 9, 2006

Related U.S. Application Data
(63) Continuation-in-part of application No. 10/278,299, filed on Oct. 23, 2002.

(51) Int. Cl. B60G 13/00

(52) U.S. Cl. 267/220

(57) ABSTRACT

A mount for a vehicle suspension comprises a resilient bushing that is formed as a separate component from a mount plate. The resilient bushing is provided with first and second radially outwardly extending lip portions having a greater radially outer diameter than a bore in the mount plate. In one embodiment, the resilient bushing is formed of two separate components, with one being mounted vertically upwardly and the other being mounted vertically downwardly into the bore. In a second embodiment, the resilient bushing is formed of a single component, and a radially upper outwardly extending portion is deformed radially inwardly to pass through the bore.

### RELATED APPLICATIONS

The present application is a continuation-in-part of U.S. patent application Ser. No. 10/278,299, filed Oct. 23, 2002.

### BACKGROUND OF THE INVENTION

The present invention relates to a mount structure for a fluid strut in a vehicle. A resilient bushing is mounted within a mount plate that attaches the mount structure to a vehicle frame. The resilient bushing is formed as a separate piece from the mount plate. Two distinct embodiments allow enlarged surfaces on the resilient bushing to be positioned on opposed ends of a smaller base in the mount plate.

Various types of vehicle suspensions are employed in modern vehicles. One common type of suspension is a McPherson strut suspension. McPherson struts typically include a hydraulic damper with a knuckle secured to the damper by fasteners. A wheel end is supported on the knuckle. A coil spring is secured to an upper portion of the strut and extending between the strut and a mount structure which mounts to the vehicle frame.

The conventional mount structure has a first upper plate, known as the “rate” plate, which is bolted to a rod on the strut. A second lower plate or “jounce bumper” is secured on the rod at a lower position. A resilient bushing is secured between the two plates, and has radially outwardly extending portions for contacting the jounce bumper and the rate plate. A mount plate is secured to a vehicle frame to mount the resilient bushing to a vehicle frame. Typically, the resilient bushing contacts the jounce bumper and the rate plate. The radially outwardly extending portions have a larger diameter than an inner bore of the mount plate.

Another feature of a lower one of the radially outwardly extending portions of the resilient bushing is that it secures a bearing seat onto the mount plate.

In the prior art, since the resilient bushing has been molded as a one piece item to the mount plate, molds have not been able to make as many parts as would be desirable. The surface area of each part has been relatively large, as required by the mount plate. Further, the requirement that there be a single component has restricted the designer in designing desired shapes to the components.

### SUMMARY OF THE INVENTION

In a disclosed embodiment of this invention, mounting structure for a strut includes a mount plate for securing a mount structure to a vehicle frame. A resilient bushing is received as a separate component from the mount plate, and has a portion mounted within an inner bore formed within the mount plate. A bearing seat is captured between a lower radially outwardly extending surface of the resilient bushing and the mount plate.

In one embodiment, this bearing seat has a radiused lower surface to facilitate movement of a radially outwardly extending upper portion of the resilient bushing through the inner bore in the mount plate.

In a second embodiment, the resilient bushing is formed of two pieces with one being brought upwardly and one being brought downwardly into the inner bore in the mount plate. A nut and threaded end of a rod of the strut secure the plates to hold the resilient bushing in compression when the component is fully assembled.

These and other features of the present invention can be best understood from the following specification and drawings, the following of which is a brief description.

### BRIEF DESCRIPTION OF THE DRAWINGS

FIG. 1 is a general perspective view of a vehicle suspension.

FIG. 2 is a sectional view of a mount system according to the present invention.

FIG. 3 is a side perspective view of a bushing for the mount system illustrated in FIG. 2.

FIG. 4 is a top perspective view of the bushing illustrated in FIG. 3.

FIG. 5 is a sectional view of another mount system according to the present invention.

FIG. 6 is a side perspective view of a bushing for the mount system illustrated in FIG. 5.

FIG. 7 is a top perspective view of the bushing illustrated in FIG. 6.

FIG. 8A is a sectional view of the FIG. 5 mount system in a first assembly condition.

FIG. 8B is a sectional view of the mount system of FIG. 8A in a second assembly condition.

FIG. 9A is a sectional view of the FIG. 3 mount system in a first assembly condition.

FIG. 9B is a sectional view of the mount system of FIG. 9A in a second assembly condition.

### DETAILED DESCRIPTION OF THE PREFERRED EMBODIMENT

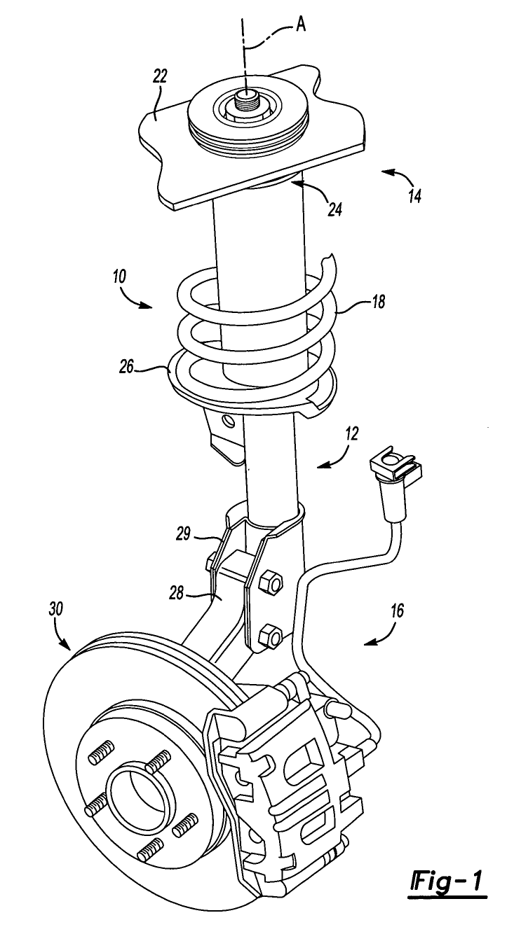

FIG. 1 illustrates a general perspective view of a vehicle suspension 10 utilizing a fluid strut such as a McPherson strut 12 which defines an axis A. The strut 12 includes upper 14 and lower 16 portions. The upper portion 14 supports a spring 18 such as a coil spring. The upper portion 14 is supported on the vehicle frame (illustrated schematically at 22) by a resilient mount system 24.

The spring 18 is retained between the mount system 24 and a fixed lower spring mount 26 attached to the strut 12. Strut 12 provides hydraulic dampening for a wheel knuckle 28 mounted at the lower portion 16 through a bracket 29 or the like. The knuckle 28 supports a brake assembly 30 and a wheel (not shown) as is well known. The strut 12 may rotate to accommodate a steering input, as is also generally known in the art.

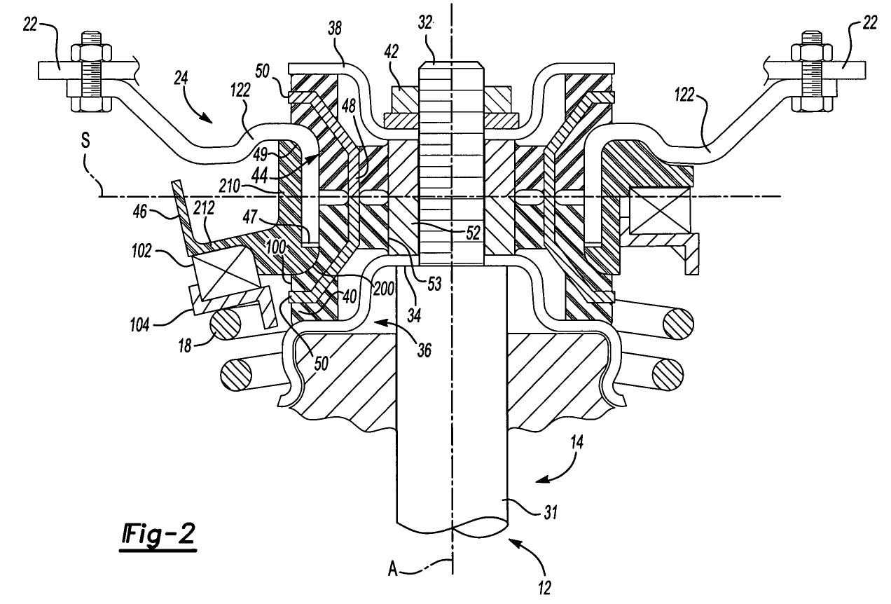

Referring to FIG. 2, a radial sectional view, which passes through axis A, further illustrates the mount system 24. The upper portion 14 of the strut 12 preferably includes a rod 31 having a threaded section 32 of a smaller diameter to define a step 34. A jounce bumper 36 forms a lower portion of mount system 24. The jounce bumper 36 is located upon the threaded section 32 adjacent the step 34.

An annular upper retention plate, or rate plate, 38 forms an upper portion of mount system 24. Rate plate 38 is separated from the jounce bumper 36 by a resilient bushing 40. Preferably, a nut 42 is threaded upon the threaded section 32 to compresses the resilient bushing 40 between the rate plate 38 and the jounce bumper 36. The rate plate 38 and the jounce bumper 36 are preferably cup shaped members with their open ends facing away from each other. The resilient bushing 40 of the mount system 24 resiliently retains the strut 12 with a cylindrical frame opening 44 in a rigid mount plate 122, which is attached to the vehicle frame 22.

A bearing seat 46 is mounted about the cylindrical frame opening 44 to provide support for bearing 102 and to assist in the insertion of the resilient bushing 40 by covering an edge 47 of the mount plate 122 with a radial pilot surface 200. Edge 47 may be relatively sharp while an angled annular upper frame area 49 opposite thereto is of a radiused shape. The radial pilot surface 200 is located adjacent to the relatively sharp edge 47 to pilot installation of the resilient bushing 40 during assembly, as will be explained below. This surface also facilitates centering of the resilient bushing 40 during operation of the strut 12.

The bearing seat 46 generally includes an annular section 210 defined about the axis A, and a mount section 212 transverse to the annular section 210. The annular section 210 is received over and around the mount plate 122. The mount section 212 extends to an annular frame area 49 to provide support for bearing 102. Notably, because the strut 12 is typically installed at an angle relative the vehicle frame 22, the mount section 212 defines a bearing seating surface for the bearing 102 that is not perpendicular to the axis A. It should be understood that various relationships may be provided by the bearing seat 46 and the angled relationship illustrated in the disclosed embodiment shall not be limiting.

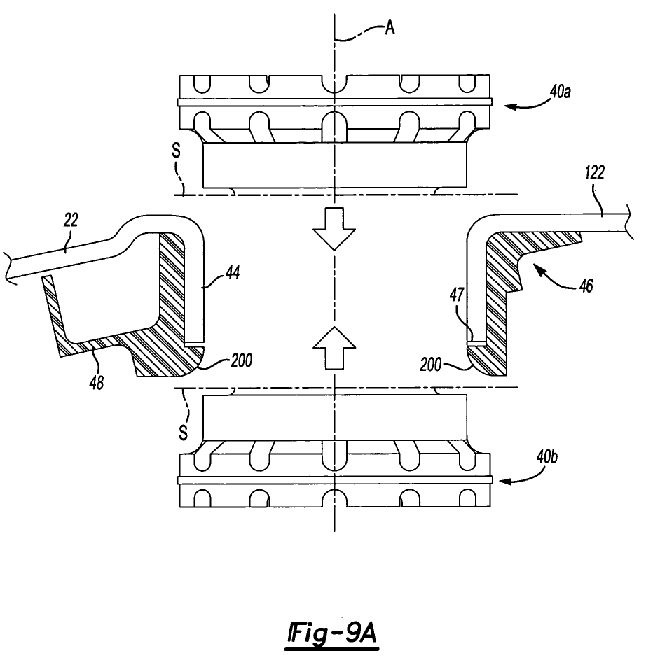

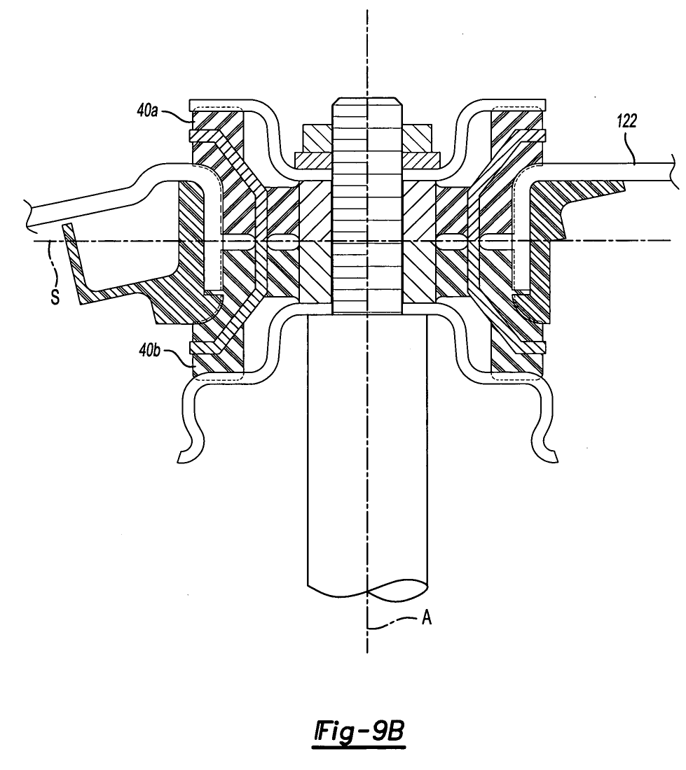

The bearing seat 46 is also at least partially retained by the resilient bushing 40. A radially outwardly extending lip 100 of the resilient bushing 40 extends beneath the bearing seat 46 to provide this retention feature. It should be understood that the bearing seat 46 and the resilient bushing 40 extend about axis A such that the bearing seat 46 also serves to pilot or position the resilient bushing 40 during assembly (FIG. 9A). Various vehicle frame and suspension structures will benefit from the mount systems of the present invention, and the present invention is not limited to the illustrated embodiment.

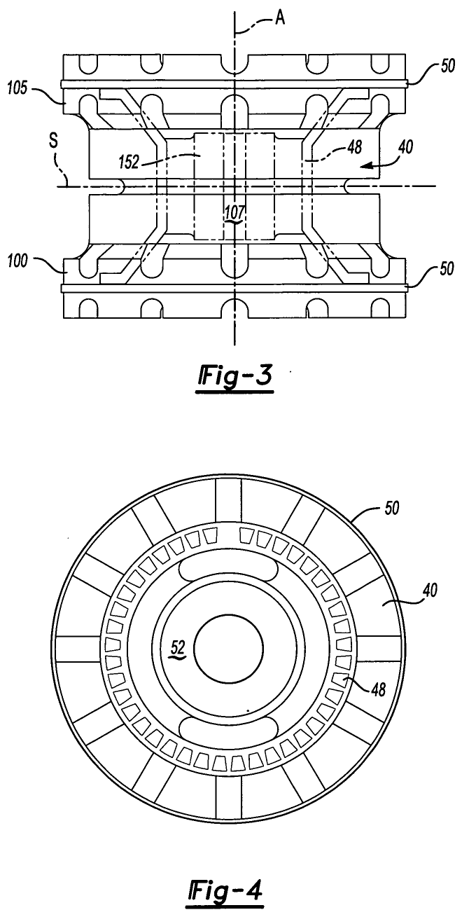

Referring to FIG. 3, the resilient bushing 40 generally includes a central section 107, an upper radially outwardly extending lip 105 and the lower radially outwardly extending lip 100. Notably, the central section 107 defines a diameter that is less than that of the lips 100, 105 such that the bushing 40 has a generally hourglass shape. Preferably, the intersections between the central section 107 and the upper and lower radially outwardly extending lips 100, 105 are radiused and are received adjacent the frame area 49 and the radial pilot surface 200 (FIG. 2). One feature of the upper radially outwardly extending lip 105, is to provide a contact surface between the rate plate 38 and the mount plate 122. Similarly, the lower radially outwardly extending lip 100 provides a contact surface between the jounce bumper 36 and the bearing seat 46.

The resilient bushing 40 may be provided with internal support from an optional annular carrier 48. The annular carrier 48 is preferably a rigid member surrounded by the resilient bushing 40 (FIG. 3). That is, the annular carrier 48 is essentially encapsulated by the resilient bushing 40. “Encapsulated” as defined herein means the resilient bushing 40 essentially surrounds the annular carrier 48, however, lip edge portions 50 or the like on the annular carrier 48 can extend at least partially through the resilient bushing 40. As shown, portions of the resilient bushing 40 are both radially inward and radially outward of the annular carrier 48. The annular carrier 48 is preferably cup shaped, facing outward relative to axis A, and essentially forms a hub upon which the resilient bushing 40 is molded.

A rigid annular member 52 is mounted within an inner diameter 53 (FIG. 2) of the resilient bushing 40 (FIG. 4). The annular member 52 is a rigid bushing that defines the distance between the rate plate 38 and the jounce bumper 36. That is, a portion of the rate plate 38 and the jounce bumper 36 contact the annular member 52 such that a proper compression is applied to the resilient bushing 40 when the nut 42 is threaded upon the threaded section 32.

In this embodiment, the resilient bushing 40, the annular carrier 48, and the annular member 52 are formed of two-pieces that are preferably mirror images when reflected through an equator S (FIG. 2). The two-piece structure allows rapid assembly in cylindrical frame opening 44.

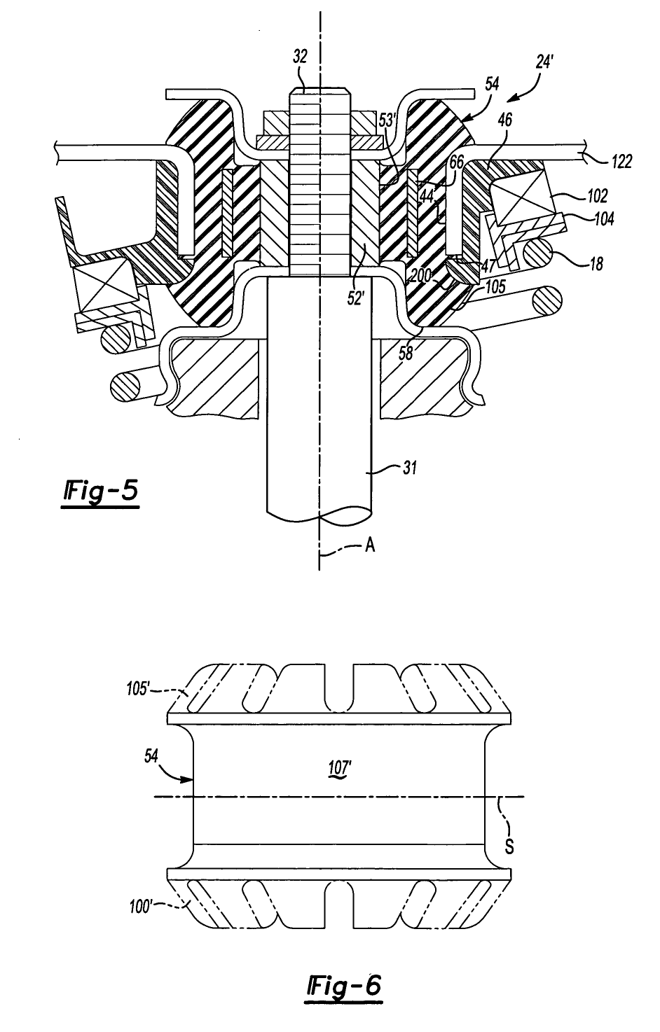

As known in the art, bearing seat 46 supports a bearing 102. A spring seat 104 (FIG. 5) is mounted on bearing 102 and spring 18 is supported on spring seat 104. The details of this structure are as known in the art and form no part of this invention.

Referring to FIG. 5, a radial sectional view, which passes through axis A of another mount system 24′, is illustrated. Mount system 24′ includes a one-piece resilient bushing 54, an optional annular carrier 66, and an annular member 52′. The resilient bushing 54, the annular carrier 66, and the annular member 52′ are each a single component.

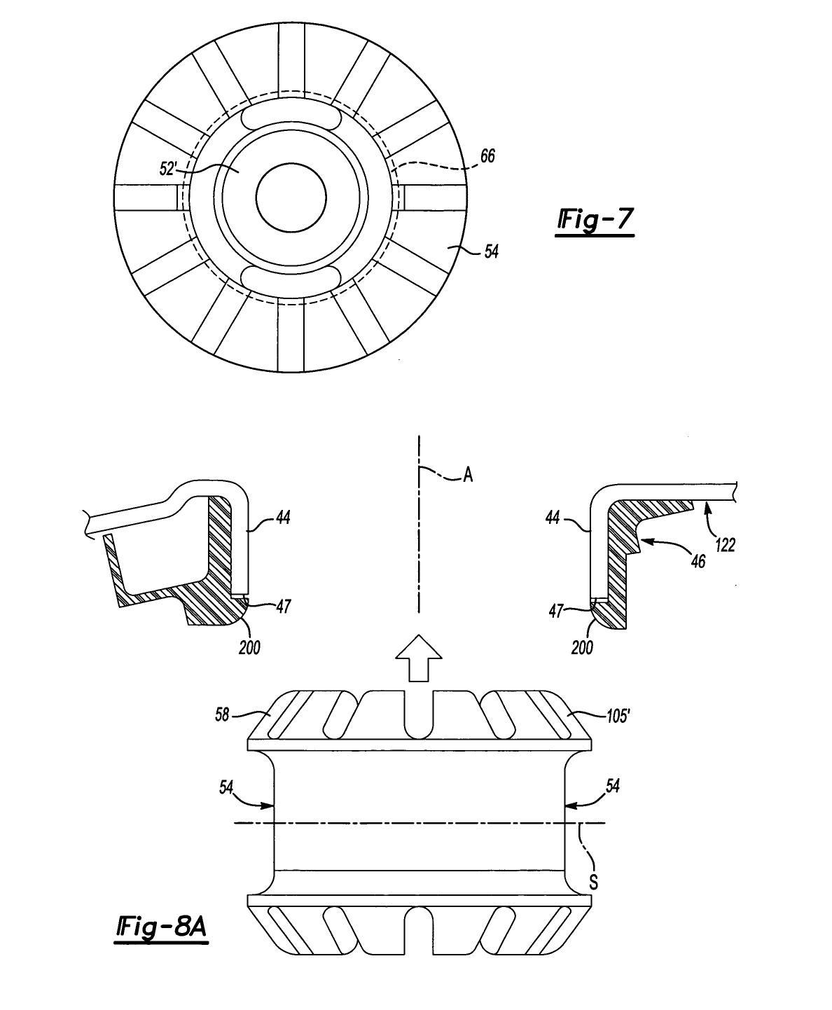

The annular carrier 66 is preferably cylindrical to assist the one-piece resilient bushing 54 with insertion through the cylindrical frame opening 44 in the mount plate 122. That is, the annular carrier 66 is generally tubular rather than having the cup shape described above, as the resilient bushing 54 is one-piece rather than two-piece. The annular member 52′ is mounted within an inner diameter 53′ of the resilient bushing 54 and functions as described above. See FIG. 7 also.

Referring to FIG. 6, the one-piece resilient bushing 54 preferably includes an arcuate chamfered surface on upper lip 105′. This surface assists in inserting the resilient bushing 54 past the bearing seat 46 and into the cylindrical frame opening 44 of the mount plate 122. A radially outwardly extending lip 100′ generally receives and retains bearing seat 46.

As can be appreciated from either FIG. 2 or FIG. 5, a radial pilot surface 200 of the bearing seat 46 is non-parallel and non-perpendicular to the axis A. In fact, as disclosed, the surface is preferably an annular radial pilot which defines a radius. The surface creates a pilot space that assists in insertion of the resilient bushings 40, 54 within the bearing seat 46 and through the mount plate 122. In particular with the embodiment of FIG. 6, this surface facilitates initial passage of the enlarged upper lip 105′ through the inner periphery of the mount plate 122 and the bearing seat 46. The upper outwardly extending lips 105, 105′ thereafter sit atop the mount plate 122.

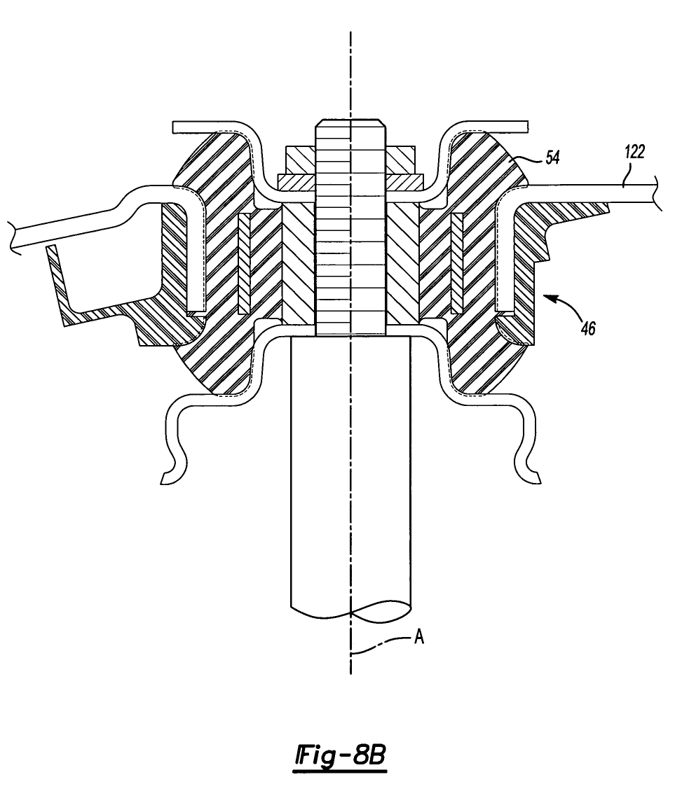

Referring to FIG. 8A, the mount system 24 of FIGS. 5-7 is illustrated in a partially assembled condition. The mount plate 122 is mounted to a vehicle frame. The bearing seat 46 is located over the cylindrical frame opening 44 such that the radial pilot surface 200 extends adjacent the edge 47. In this way, the bearing seat 46 facilitates installation of the resilient bushing 54 while minimizing the potential for damage as the radially outwardly extending lip 105′ of the resilient bushing 54 is compressed to pass through the smaller diameter cylindrical frame opening 44 until reaching an installed position. The resilient bushing 54 is maintained slightly in compression (illustrated schematically by the dashed line in FIG. 8B) once installed.

Although FIG. 8A utilizes the resilient bushing 54 of FIG. 5, it should be understood that installation is likewise generally similar for the embodiment of FIG. 2. Referring to FIG. 9A, the resilient bushing 40 is symmetrical about the equator S to define a two-piece structure 40a, 40b. The two-piece structure provides for assembly into the cylindrical frame opening 44 from each side of the mount plate 122. Here, the bearing seat 46 need not provide as significant of the pilot function as described with reference to FIGS. 8A, 8B but does provide for centering alignment within the cylindrical frame opening 44 during operation. The bearing seat 46 also minimizes stresses upon the resilient bushing which may otherwise occur should the edge 47 be exposed as in conventional bearing seat arrangements known in the prior art. Here too, the resilient bushing 40 is maintained in compression (illustrated schematically in FIG. 9B) once installed. Furthermore, the two-piece structure 40a, 40b of the resilient bushing 40 is retained together by the interaction between the step 34, nut 42, rate plate 38, and jounce bumper 36 (FIG. 2).

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A resilient mount system for a vehicle suspension comprising:
a rod forming a portion of a fluid damper, said rod having a threaded upper end;
a rate plate secured on said threaded upper end of said rod;
a resilient bushing having an enlarged upper lip and a smaller portion spaced away from said rate plate relative to said enlarged upper lip; and
a mount plate for mounting the resilient mount system to a vehicle frame, said mount plate having a central bore with said enlarged upper lip having a greater dimension than said central bore, and said resilient bushing being formed as a separate component from said mount plate.

2. The system as set forth in claim 1, wherein a bearing seat is captured between said mount plate and an enlarged lower lip of said resilient bushing spaced on an opposed side of said smaller portion compared to said enlarged upper lip.

3. The system as set forth in claim 2, wherein said bearing seat has a radiused surface facing said enlarged lower lip that guides said resilient bushing into said central bore.

4. The system as set forth in claim 3, wherein said resilient bushing is formed as a one-piece component, and said radiused surface facilitating radially inward deformation of said enlarged upper lip to pass through said central bore.

5. The system as set forth in claim 3, wherein said resilient bushing is formed of two components, with a first component having said enlarged lower lip and received in said central bore to capture said bearing seat against said mount plate.

6. The system as set forth in claim 5, wherein a second component carries said enlarged upper lip.

7. The system as set forth in claim 2, including a jounce bumper positioned on an opposed side of said resilient bushing from said rate plate, said jounce bumper being in contact with said enlarged lower lip.

8. The system as set forth in claim 1, further comprising a rigid annular member mounted within an inner diameter of said resilient bushing.

9. A mount system for a vehicle suspension comprising:
a resilient bushing having an enlarged upper lip and a smaller portion spaced away from a rate plate relative to said enlarged upper lip; and
a mount plate for mounting said mount system to a vehicle frame, said mount plate having a central bore with said enlarged upper lip having a greater dimension than said central bore, and said resilient bushing being formed as a separate component from said mount plate.

10. The system as set forth in claim 9, wherein a bearing seat is captured between said mount plate and an enlarged lower lip of said resilient bushing spaced on an opposed side of said smaller portion compared to said enlarged upper lip.

11. The system as set forth in claim 10, wherein said bearing seat has a radiused surface facing said enlarged lower lip that guides said resilient bushing into said central bore.

12. The system as set forth in claim 11, wherein said resilient bushing is formed as a one-piece component, and said radiused surface facilitating radially inward deformation of said enlarged upper lip to pass through said central bore.

13. The system as set forth in claim 11, wherein said resilient bushing is formed of two components, with a first component having said enlarged lower lip and received in said central bore to capture said bearing seat against said mount plate.

14. The system as set forth in claim 13, wherein a second component carries said enlarged upper lip.

15. The system as set forth in claim 9, further comprising a rigid annular member mounted within an inner diameter of said resilient bushing.

16. A method of assembling a resilient mount for a fluid strut comprising the steps of:
1) providing a mount plate for securing the fluid strut to a vehicle frame, said mount plate defining an inner bore having an inner diameter;
2) providing a resilient bushing as a component separate from said mount plate, and said resilient bushing having a first radially outwardly extending portion of an outer diameter greater than said inner diameter of said inner bore, and a second radially outwardly extending portion also having a greater radially outward diameter than said inner diameter of said inner bore; and
3) inserting said resilient bushing into said inner bore, and then securing a rod for a fluid damper to hold said resilient bushing to said mount plate.

17. The method as set forth in claim 16, wherein said resilient bushing is formed of a single component, and including deforming said first radially outwardly extending portion radially inwardly to pass through said inner bore.

18. The method as set forth in claim 16, wherein said resilient bushing is formed of two pieces, with one piece being inserted in a first direction into said inner bore and the second piece being inserted into said inner bore in an opposed direction.

19. The method as set forth in claim 16, wherein a bearing seat is captured between said second radially outwardly extending portion and said mount plate, said bearing seat having a radiused inner diameter portion to facilitate movement of said resilient bushing into said inner bore.
